(19) United States
(12) Patent Application Publication
(10) Pub. No.: US 2024/0365041 A1
(43) Pub. Date: Oct. 31, 2024

(54) EARTIP

(71) Applicant: GN Audio A/S, Ballerup (DK)

(72) Inventors: Johan BIRGER, Ballerup (DK); Henrik BJÖRKVALD, Ballerup (DK); Troels HAMMER, Ballerup (DK); Jonas HOLFELT, Ballerup (DK); Martin LINDEBJERG, Ballerup (DK); Morten LUNDE, Ballerup (DK); Lars PERSSON, Ballerup (DK); Dan Fiirgaard SCHNEEFELDT, Ballerup (DK)

(21) Appl. No.: 18/641,820

(22) Filed: Apr. 22, 2024

(30) Foreign Application Priority Data
Apr. 25, 2023 (EP) 23169820.0

(51) Int. Cl. H04R 1/10

(52) U.S. Cl. CPC H04R 1/1016

(57) ABSTRACT

The disclosure relates to an eartip for a hearing device the eartip comprising a core and a skirt formed around the core, the core forming an inner channel with a top opening and a bottom opening for detachably attaching the eartip to the hearing device. The eartip defines an eartip bottom end and an eartip top end, a bottom plane of the bottom end and a top plane of the top end is configured to intersect in space. The circumference of the skirt is configured to change from the bottom plane towards the top plane. The bottom opening forms a unidirectional interface.

### CROSS-REFERENCE TO RELATED APPLICATION

This application claims the benefit of priority from European Application No. 23169820.0 filed 25 Apr. 2023, the entire contents of which are incorporated herein by reference.

### TECHNICAL FIELD

The present disclosure relates to an eartip for a hearing device. More specifically, the disclosure relates to an eartip as defined in the introductory parts of claim 1.

### BACKGROUND ART

Earphones are a pair of electronic equipment having speaker drivers and are typically worn inside or at least partly inside user's ears. They convert an electrical signal to a corresponding sound. Earphones allow a single user to listen to an audio source privately, in contrast to a loudspeaker, which emits sound into the open air for anyone nearby to hear. Earphones are also known as ear speakers, earbuds, or headset. Earphones typically have two earbuds. An earbud is an individual unit that fits into the user's outer ear and/or the user's ear canal. During use, all earbuds create discomfort on the user's ears and therefore it is important to design the earbuds to be comfortable for the user. With in-ear earphones in which a tip of earbud is arranged in the ear canal, the tip presses against the user's ear canal and a build-up of discomfort occurs during prolonged use. There is thus a need for an improved earphones which provides good comfort for the user.

True wireless stereo earbuds are greatly dependent on its eartip, so called, eargels for both acoustic seal, secure fit and comfort in the ear canal. Secure fit can be improved in most ears by positioning the tip of the eargels so they sit just around the first bend in the ear canal forming a hook. In existing earphones this secure hook has been achieved by curving a speaker tower of the earbud. The speaker tower is curved just around the first ear canal bend and then a standard mushroom type eargel is mounted on the speaker tower. While this improves secure fit, it also causes discomfort in the user's ears and gives a more intrusive feeling, especially compared to a shallow sealing tower and an eargel mounted thereon. The curved speaker tower also prevents a wide-open output hole required for good active noise cancellation (ANC) performance, because the speaker tower has to be very small to fit in as many ear canals as possible.

On the other hand, shallow sealing ANC earbuds have a very wide tower opening. However, such speaker tower must be arranged closer to the opening of the ear canal. When mounted with known eargels, such arrangement prevents the earbud from utilizing the first ear canal bend for secure fit. Users of the shallow sealing ANC earbuds report issues related to loose fit and a need to arrange the earbud deeper in the ear canal for better fit, which then causes pain as the hard speaker tower touches the opposite wall of the first bend of the ear canal.

To provide true wireless earbuds that ensure secure fit and good comfort there is thus a need for an improved design of eargels to thereby provide both good comfort, secure fit, as well as ensure good active noise cancellation.

### SUMMARY OF THE INVENTION

It is an object of the present disclosure to mitigate, alleviate or eliminate the above-identified deficiency and disadvantage in the prior art and solve at least the above mentioned problem.

It is an object of the embodiments of the present invention to provide a comfortable eartip for earphones.

It is a further object of the embodiments of the present invention to provide earphones with a soft and comfortable eartip that fits well in the user's ear.

It is a yet further object of the present invention to provide an in-ear earphones which create a decreased pressure on the user's ear canal compared to known earphones.

It is a further object of the embodiments of the present invention to provide earphones with a long-term comfort and secure fit.

According to a first aspect there is provided an eartip for a hearing device. The eartip comprises a core and a skirt. The skirt is formed around the core. The core forms an inner channel with a top opening and a bottom opening for detachably attaching the eartip to the hearing device. The eartip defines an eartip bottom end and an eartip top end. A bottom plane of the bottom end and a top plane of the top end are configured to intersect in space. The perimeter of the skirt is configured to change from the bottom plane towards the top plane. The bottom opening forms a unidirectional interface. The unidirectional cross-section is convex. A shape is called convex if, for any two points in the shape, the straight line segment joining them lies entirely within the shape.

In the present context, the eartip is to be understood as an element that can be detachably attached to a housing of the hearing device. Sometimes, the eartip is referred to as an eargel or an earbud tip. Typically, the eartip is a passive element, i.e. without any electronic components. The eartip may be produced in different sizes to fit different ear sizes. The eartip may be sold separately from a hearing device.

The hearing device may be configured for audio communication, e.g. enabling the user to listen to media, such as music or radio, and/or enabling the user to perform phone calls. The hearing device may be configured for performing hearing compensation for the user. The hearing device may be configured for performing noise cancellation etc.

The eartip comprises a core and a skirt. In the present context, the core is to be understood as a portion of the eartip configured to attach to the hearing device and, typically, is not in a direct contact with the user's ear when the eartip is arranged thereto. The skirt is to be understood as a portion of the eartip configured to abut the user's ear canal when the eartip is arranged thereto. Typically, the core and the skirt form an integral part and may not be separated without damaging the eartip.

The skirt is formed around the core. Typically, the core is at least partly surrounded by the skirt. In some embodiments, the entire core may be surrounded by the skirt. The top opening of the core may, at the same time, form a top section of the skirt.

The core forms an inner channel with a top opening and a bottom opening. The bottom opening is configured to detachably attach the eartip to the hearing device and to guide the sound from the hearing device through the inner channel and the top opening into the user's ear. The inner channel extends from the bottom opening to the top opening and is configured to guide the sound from the hearing device into the user's ear. The core may define an inner wall and an outer wall, the outer wall may face the skirt while the inner wall may define attachment surfaces for attaching to the hearing device and a surface for appropriate guiding of the sound.

The eartip defines an eartip bottom end and an eartip top end. Typically, the eartip top end is defined by the top opening of the core and the section of the skirt extending from the top opening of the core. The eartip bottom end is typically defined by the skirt and the lowest section of the skirt. The eartip top end is to be understood as the portion of the eartip that is arranged the deepest in the ear canal, when the eartip is arranged on the hearing device and in the user's ear.

The bottom plane may be defined as a plane comprising the bottom end and a top plane may be defined as a plane comprising the top end and the top opening. These two planes are intersecting planes, i.e., configured to intersect in space thereby defining the eartip overall shape. The bottom opening of the core may be either between the top and bottom planes or below the bottom plane.

The perimeter of the skirt changes from the bottom plane towards the top plane. In the present context, the perimeter of the skirt is to be understood as a brim around the skirt measured at any cross-section along the skirt from the bottom end to the top end. In other words, a horizontal cross-section of the skirt changes, typically gradually, from the bottom end to the top end. Terms perimeter and circumference will be used interchangeably throughout the text. When the eartip is inserted into the ear, the overall shape of the eartip may change to follow the shape of the ear canal.

The bottom opening forms a unidirectional interface. In the present context, the term unidirectional interface is to be understood as the interface that can be attached to the hearing device in only one correct way. The unidirectional interface has at least one axis of asymmetry. This axis of asymmetry defines that the eartip cannot be arranged on the hearing device in a random way, but rather in only one predetermined way. At least one axis of asymmetry may comprise the centroid of the unidirectional interface. At least a portion of the inner channel starting from the bottom opening may also have a unidirectional profile.

The eartip has at least one axis of symmetry and thereby, the same eartip can be used for both left and right mounting, i.e. for both left and right hearing device. The way of mounting the eartip onto the hearing device, i.e. the direction of mounting is secured by the unidirectional interface which allows for only one rotational direction mounting. The unidirectional interface is compatible with both left and right mounting. It is crucial that the eartip is mounted correctly, as an incorrect orientation on the speaker tower may cause insecure fit, reduce comfort and impact acoustic seal between the hearing device and the eartip. Furthermore, the eartip is shaped to resemble the ear canal, i.e., it is angled into the ear and follows canal shape, typically being elliptical.

In some embodiments, the unidirectional interface has a cross-section that matches a cross-section of a speaker tower of the hearing device. The hearing device comprises the speaker tower configured to deliver sound into the user's ear. It is preferred to have as wide as possible speaker tower, for instance a speaker tower with a perimeter larger than 10 mm and a total area of more than 10 mm². As the unidirectional interface is configured to be arranged on the speaker tower, it is preferred to have as wide as possible bottom opening, for instance a bottom opening with a perimeter larger than 10 mm and a total area of more than 10 mm². Also, it is preferred to have a shallow speaker tower, i.e. a speaker tower that is not taller than 10 mm. thus, it is preferred to have the core with a first section extending from the bottom opening and have a length no longer than 10 mm. The speaker tower may enter the ear canal and if it is taller than 10 mm it may result in user's discomfort when using the hearing device. The eartip according to the present disclosure is designed to fit a wide and shallow speaker tower by matching the speaker tower cross-section which, naturally, is also designed to have a unidirectional shape that corresponds to the unidirectional shape of the eartip. In this way, it is ensured that the eartip can be arranged onto the speaker tower in only one way. By having the eartip with the unidirectional cross-section that fits onto the speaker tower in only one way it is ensured that the user will mount the eartip correctly. Namely, the user is guided by the unidirectional interface to mount the eargel correctly. It is crucial that the eartip is mounted correctly, as an incorrect orientation on the speaker tower will cause insecure fit, reduce comfort and impact acoustic sealing between the hearing device (speaker tower) and the eartip. The unidirectional cross-section may be oval with a groove, triangular, trapezoidal, pentagonal, etc. The unidirectional cross-section may be any cross-section that is asymmetrical with respect to at least one central axis.

In some embodiments, the unidirectional interface defines a fitment inside the inner channel of the core. The fitment is to be understood as an engagement section or a portion inside the inner channel configured as a fail-proof coupling with the speaker tower, i.e. a coupling that can couple to the speaker tower in only one correct way. The inner channel may define an inner waist that is configured to fit at least partly around the speaker tower. Such eartip ensures improved secure fit, and at the same time removes a disadvantage of a tall speaker tower that causes discomfort in the user's ears and give a more intrusive feeling. The inner channel extending from the bottom opening to the top opening may be defined by a plurality of sections. A first section may be the fitment configured to engage with the speaker tower. The first section may define grooves and/or protrusions configured to mate with protrusions and grooves of the speaker tower, thereby defining the fitment. The first section may have a unidirectional cross-section configured to couple with the speaker tower. The first section of the core may provide sealing around the speaker tower. A second section of the inner channel may be a continuation of the first section and may be configured to bend when the eartip is arranged in the user's ear to thereby improve comfort. The second section may extend above the speaker tower when the eartip is arranged on the hearing device. The second section of the inner channel may have any cross-section, i.e. a cross-section that is not related to the cross-section of the speaker tower. The second section of the core may have oval cross-section. The top opening may follow the cross section of the second core section and may, for instance, be oval. The second section of the inner channel may be bent with respect to the first section. The bended second section of the inner channel may follow bending of the ear canal. By having the second section of the core bended it is allowed that the speaker tower is short and does not necessarily extend into the first bend of the ear canal, as it is the case in many hearing devices known in the art. The core may be made of a soft and flexible material such as silicone. Such extended soft and thereby bendable core allows for deformation of the core around the first bend of the ear canal. The core may also be angled with respect to the bottom plane and the angle may follow the angle of the first bend of the ear canal that is on average about 35 degrees with a standard deviation around 10 degrees, which means 95% of the population has a first bend angle within 35+/−20 degrees. The angle of the core with respect to the bottom plane may be around 55 degrees and due to flexibility of the material which the core is made from, the core may bend to thereby form angles in the range between 32-77 degrees, such as 42-67 degrees, with respect to the bottom plane resulting in increased wearing comfort. The second section of the core may have a wider cross-section compared to the first section and/or compared to the speaker tower. Such cross-section that is wider than the speaker tower gives a lower acoustic impedance than a narrower cross section what results in improved ANC properties.

In some embodiments, the unidirectional interface forms a polygon. As the polygon is convex, all internal angles between two neighbouring line segments are less than 180 degrees. The polygon may have more or less rounded segments between the line segments.

In some embodiments, the unidirectional interface comprises straight lines and curved lines.

In some embodiments, the unidirectional interface has an essential triangular cross-sectional shape. The triangular cross-section may have rounded corners to retain acoustic sealing around the speaker tower. The triangular interface may have at least one side different from the other two sides. The triangular interface may form an isosceles triangle or a scalene triangle. Two of the three sides may have the same length, and a third side may a different length. Two of the three angles be the same, and a third angle may be different. It is beneficial from a manufacturing perspective to have the core with the triangular interface to the speaker tower, as it is easier to manufacture a triangular speaker tower than, for instance, a pentagonal cross-sectional shape or more complex unidirectional shapes. In general, i.e. regardless of the specific cross-sectional shape, the unidirectional interface may be configured to provide acoustic sealing around the speaker tower. By providing acoustic sealing around the speaker tower any sound leakage from the hearing device is prevented thereby ensuring improved sound properties and improved ANC. Furthermore, the triangular shape allows the eartip to fit on both left and right hearing device while the curvature of the skirt is in the correct direction and the user cannot arrange the eartip in the wrong rotation.

In some embodiments, the eartip bottom end is configured to be proximate to the hearing device and the eartip top end is configured to be distal from the hearing device, when the eartip is arranged at the hearing device. In some embodiments, the eartip bottom end may be formed to at least partly contact a housing of the hearing device. In some embodiments, the eartip bottom end may be formed to contact the housing of the hearing device along its entire circumference.

According to some embodiments, the eartip is symmetrical around a first vertical central plane. By having the eartip with a symmetry around one vertical central plane it is ensured that the eartip is configured to be used for both the left and the right ear of a user. The first vertical central plane may extend from the bottom end towards the top end of the eartip. The bottom end may be symmetrical about a minor central bottom axis. The top end may be symmetrical about a minor central top axis. The first vertical central plane may pass through the bottom end along the minor central bottom axis and through the top end along the minor central top axis. The first vertical central plane may be the only vertical plane along which the eartip is symmetrical.

According to some embodiments, the eartip is asymmetrical around a second vertical central plane, such that the skirt defines a first length forward of the second vertical central plane and a second length backward of the second vertical central plane, the first length being shorter than the second length. The eartip may have a first height forward of the second vertical central plane and a second height backward of the second vertical central plane, the first height being shorter than the second height. The first length may be longer than the first height and the second length may be longer than the second height. The second vertical plane may be perpendicular to the first vertical plane. The bottom end may be symmetrical about a major central bottom axis. The second vertical central plane may pass through the bottom end along the major central bottom axis. The major central bottom axis may be perpendicular to the minor central bottom axis. The ratio between second length and the first length may be between 1.5 and 4, and typically around 2. This ratio may define how deep the eartip can be arranged in the ear canal. By designing the skirt having different lengths along opposing surfaces an advantageous profile of the eartip is achieved, i.e., the eartip with a shape that follows the bending of the ear canal is achieved, what finally results in improved comfort for the user. While the depth in the canal may be arbitrary, it is identified that a desirable eartip length that appears to provide the right balance between secure fit effect and a non-intrusive wearing feeling is between 5-12 mm. The length of the eartip determines a depth of the eartip insertion. The length around 5-7 mm is optimized for non-intrusive wearing feeling while a longer eartip provides improved secure fit effect.

In some embodiments, a center of the bottom end of the eartip is off-set with respect to a center of the top end of the eartip such that the eartip is tilted with respect to a second vertical central plane. The center of the bottom end may be defined as the crossing point of the major central bottom axis and the minor central bottom axis. The center of the bottom end may be the centroid of the bottom end. Similarly, the center of the top end may be the centroid of the top end. By stating that the two centers are off-set from each other it is meant that the centroid of the top end does not lie on a vertical axis defined by the centroid of the bottom end and being perpendicular to the bottom end. Thereby, the eartip defines a bend between the bottom end and the top end, the bend comprising an interior curve and an opposite, exterior, curve that are sized and shaped to facilitate insertion of the eartip at or near the first bend of the ear canal. The interior curve may be determined by the first length of the skirt and the exterior curve may be determined by the second length of the skirt.

In some embodiments, the top end is angled with respect to the bottom end. In other words, the planes of the top end and of the bottom end are not parallel. The core may be perpendicular to the top end and thus, arranged at an acute angle with respect to the bottom end.

In some embodiments, the eartip defines a bend between the bottom end and the top end. The bend may comprise an interior curve and an opposite curve that are sized and shaped to facilitate insertion of the eartip at or near the first bend of the ear canal. The core may be configured to bend at or near the first bend of the ear canal, when the eartip is inserted into the ear. The interior curve and the curve opposite to the interior curve may be defined by the skirt. In other words, the skirt may comprise the interior curved surface and the opposite curved surface. The interior curve may have a shorter length (measuring from the bottom end to the top end) compared to the opposite curve. The height of the eartip may be shorter than the length of the opposite curve. The opposite curve may be angled with respect to the bottom end. A tangent to the opposite curve may form an acute angle with the bottom end while a tangent to the inner curve may form a straight or obtuse angle with the bottom end thereby defining an angled eartip shaped to facilitate insertion into the first bend of the ear canal.

In some embodiments, the eartip is made of a thermoplastic elastomer. The eartip may be made of silicone. The eartip may be made of a polyurethane. The eartip may be made of a memory foam. In general, the eartip may be made from a material that can be inserted into the ear canal and that can be molded into the shape according to the present disclosure. The eartip made of silicone is easy to manufacture, as manufacturing processes for silicone are well-established.

In some embodiments, the skirt has a first hardness value, and the core has a second hardness value. The first hardness value is lower than the second hardness value. The eartip skirt can remain curved in a softer silicone for comfort with a shore between 30 A and 60 A while the eartip core may be harder to snap tight around the speaker tower with a shore of around 70-80 A.

In some embodiments, the core comprises a section that is tilted with respect to a speaker tower of the hearing device, when the eartip is arranged at the hearing device. In some embodiments, the core may be configured to tilt with respect to the speaker tower when the eartip is arranged on the hearing device and inserted into the ear thereby improving comfort for the user. The central axis of the core, i.e. of the inner channel, may be perpendicular to the top end and forming an acute angle with the bottom end. Such angled core improves comfort for the user when wearing the hearing device.

In some embodiments, the core and the skirt are integrally connected thereby forming the top end of the eartip. In other words, the core may extend from the top end of the eartip where the top opening is formed and towards the bottom end while being surrounded by the skirt. The core and the skirt may together form an integral part defining the eartip. The core and the skirt may be made of the same material. The second section of the core may continuously extend into the top end and the top end may then continuously extend into the skirt.

In some embodiments, the inner channel of the core comprises a grid arranged within the channel. The grid may be formed inside the core to preventing the build-up of ear wax in the core of the eartip and further into the hearing device. The grid may be formed between the first core section that connects to the speaker tower and the second section that forms extension of the core.

In some embodiments, the horizontal cross-section of the eartip is substantially oval. The horizontal cross-section may be defined by a plane parallel to the bottom end. In some embodiments the bottom end may be round, or circular, or oval, or elliptical. The top end may also take one of these shapes, however typically, the top end has a smaller cross-section compared to the bottom end. In a preferred embodiment, the bottom end and the top end have oval shapes, such as elliptical shapes, the top end being smaller than the bottom end. The oval shape of the eartip results in improved acoustic seal of the ear. The ratio between the minor and major axis of the oval bottom end may correspond to the ratio between the width and height of the ear canal. The ratio between the minor and major axis of the oval bottom end may be between 1.1 to 1.5, such as approximately 1.2. If the ratio between the two axis is larger than 1.5, the eartip capability to deform may be compromised. On the other hand, if the ratio is smaller than 1.1, acoustic sealing properties of the eartip may be impacted.

In some embodiments, the bottom opening for interfacing the eartip with the hearing device comprises a protrusion configured to seal the interface between the eartip and the hearing device. The protrusion may correspond to features of the speaker tower and may be configured to mate with these features to thereby ensure better sealing between the speaker tower and the eartip. This sealing is in particular important for improving ANC properties of the hearing device.

In some embodiments, the eartip is configured to at least partly acoustically seal an ear of the hearing device user. The eartip is shaped in such a way to improve acoustic sealing of the ear and to thereby improve sound properties of the hearing device. The eartip is shaped to facilitate insertion into the ear and additionally, the eartip may be made of a material that can bend and thereby further improve acoustic sealing of the ear.

In some embodiments, the eartip is configured to retain the hearing device in an ear of the hearing device user. The eartip is shaped in such a way to ensure that the hearing device remains at the user's ear. The eartip may be understood as being a retaining element for the hearing device. The perimeter of the bottom end may be between 20-25 mm and the perimeter of the top end may be between 12-16 mm. The skirt may have perimeter between 10-30 mm along its length. Having the skirt which perimeter is smaller at the top end than at the bottom end, retaining properties of the eartip are improved.

In some embodiments, the core is shorter than the skirt. In this embodiment, the skirt may completely cover the core. The core may extend from the top plane where the top opening is formed and to the bottom opening, the bottom opening being above the bottom end of the eartip. In this embodiment, the skirt may be in contact with the housing of the hearing device and the bottom end of the eartip is defined by the skirt. Alternatively, the skirt may be shorter than the core. In this embodiment, the core may extend from the top plane and further below the bottom end of the eartip defined by the skirt. The bottom opening may be below the bottom end. In this embodiment, the skirt may not be in contact with the housing of the hearing device. In some embodiments, the bottom opening and the bottom end may lie in the same plane.

In some embodiments, the circumference of the skirt is configured to decrease from the bottom plane towards the top plane. The circumference of the skirt may continuously and gradually decrease from the bottom plane towards the top plane. The eartip with the skirt which circumference decreases as the eartip is deeper in the ear canal provides improved acoustic sealing and thereby better ANC properties of the hearing device.

According to some embodiments, the circumference of the skirt increases from the bottom plane up to a mid-plane between the bottom plane and the top plane, and the circumference of the skirt decreases from the mid-plane up to the top plane. Both the increase and decrease of the circumference of the skirt may be continuous and gradual. The eartip with the skirt which circumference decreases as the eartip is deeper in the ear canal provides and also having a bottom portion with a skirt which circumference increases, at the same time provides improved acoustic sealing and thereby better ANC properties of the hearing device and easier insertion of the hearing device as well as placement of the eartip onto the hearing device. A larger circumference near the middle of the skirt relative to the bottom plane may provide improvement in structural stability to the shape of the skirt and help to prevent buckling (a phenomenon where the eargel skirt folds together when exposed to pressure from the ear canal walls, forming a leak channel along the length of the skirt).

The eartip may press against the user's ear canal to thereby enable acoustic sealing and secure fit of the hearing device during use. To ensure a good acoustic sealing and secure fit of the hearing device during use, the eartip surface interfacing with the ear canal typically defines a continuous oval surface. This surface is typically made from silicone, ensuring good feeling in the ear and suitable friction. The eartip may be removably attached to the hearing device.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTION OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIGS. 1a and 1b schematically illustrate a cross-sectional view of an eartip for a hearing device according to different embodiments of the invention;

FIGS. 2a and 2b schematically illustrate an eartip arranged on a hearing device and in a user's ear;

FIGS. 3a and 3b schematically illustrate an eartip arranged on the hearing device;

FIGS. 4a, 4b, 4c, 4d, 4e and 4f schematically illustrate a bottom view of an eartip for a hearing device according to various embodiments of the invention;

FIGS. 5a and 5b schematically illustrate an anterior (a) and top (b) view of an eartip for a hearing device according to one embodiment of the invention;

FIG. 6 schematically illustrates an eartip according to one embodiment of the invention.

### DETAILED DESCRIPTION

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

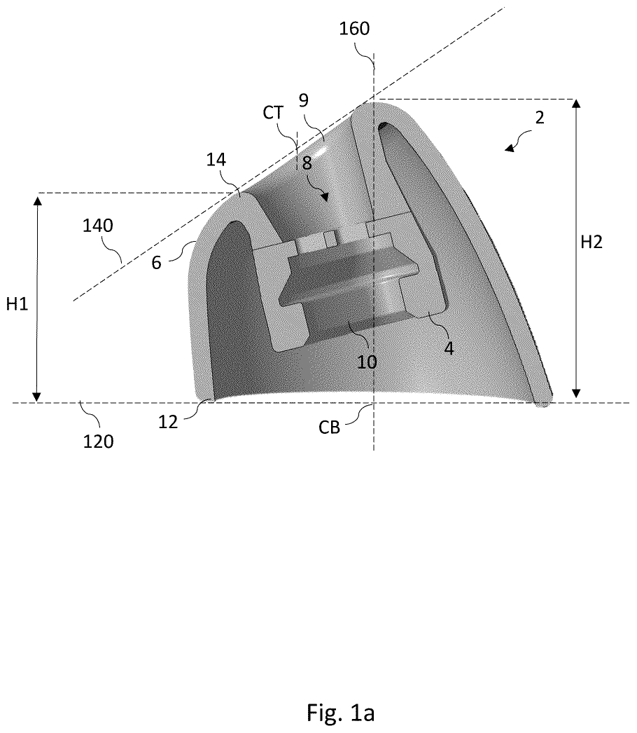

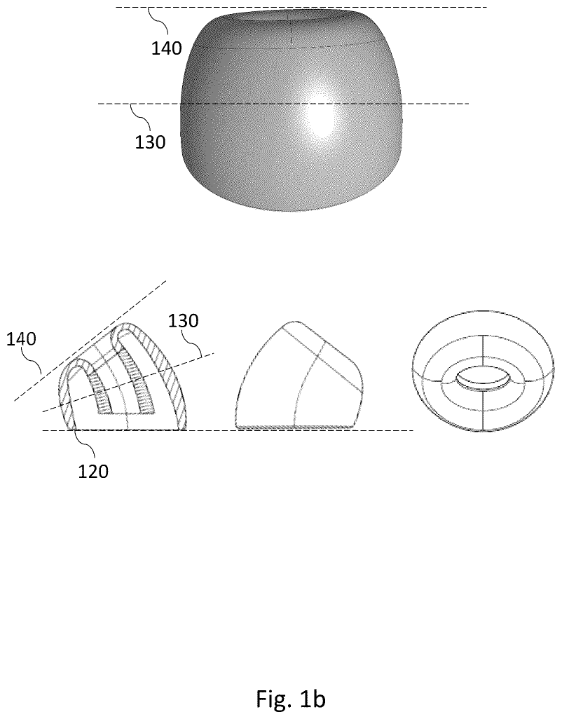

FIG. 1a schematically illustrates a cross-sectional view of an eartip 2 for a hearing device according to one embodiment of the invention. The eartip is to be understood as an element that can be detachably attached to a housing of a hearing device. The eartip 2 comprises a core 4 and a skirt 6. The skirt 6 is formed around the core 4. The core 4 forms an inner channel 8 with a top opening 9 and a bottom opening 10. The bottom opening 10 is configured for detachably attaching the eartip 2 to the hearing device (not shown). The eartip 2 defines an eartip bottom end 12 and an eartip top end 14. A bottom plane 120 of the bottom end 12 and a top plane 140 of the top end 14 are configured to intersect in space (the two lines defining the planes 120 and 140 will eventually intersect in space). The circumference of the skirt 6 is configured to change from the bottom plane 120 towards the top plane 140. The bottom opening 10 forms a unidirectional interface.

In the embodiment illustrated in FIG. 1a, the circumference of the skirt 6 decreases from the bottom plane 120 towards the top plane 140.

In the embodiment illustrated in FIGS. 1a and 1b, the bottom opening 10 of the core is placed between the top end 14 and the bottom end 12. In another embodiment, the core may be longer than the skirt 6 such that the bottom opening 10 forming the unidirectional interface may be arranged below the bottom end 12. FIGS. 1a and 1b illustrate the eartip cut along a first vertical central plane. The first vertical central plane extends from the bottom end 12 to the top end 14 of the eartip and comprises centroids of both the top end and the bottom end. The bottom end 12 is symmetrical about a minor central bottom axis comprising the centroid of the bottom end. The first vertical central plane passes through the bottom end along the minor central bottom axis. The top end is also symmetrical about a minor central top axis. The first vertical central plane passes through the top end along the minor central top axis. The first vertical plane is a plane of symmetry.

The eartip is asymmetrical around a second vertical central plane 160 that comprises the major bottom axis and is perpendicular to the bottom plane 120. The skirt 6 defines a first height H1 forward of the second vertical central plane 160 and a second height H2 backward of the second vertical central plane 160, the first height being shorter than the second height.

The center CB of the bottom end 12 of the eartip is off-set with respect to the center CT of the top end 14 of the eartip such that the eartip is tilted with respect to the second vertical central plane 160. The tilt of the eartip is advantageous as it facilitates insertion of the eartip into the ear canal. Namely, the tilt of the eartip is designed to follow the curvature of the first bent of the ear canal. Furthermore, the core 4 and its inner channel 8 extending from the top plane is off-set from the center CB of the bottom end and follows the tilt of the eartip.

FIG. 1b schematically illustrates various cross-sectional views of an eartip for a hearing device according to another embodiment of the invention. In this embodiment illustrated in FIG. 1b, the circumference of the skirt increases from the bottom plane up to a mid-plane 130 between the bottom plane 120 and the top plane 140, and wherein the circumference of the skirt 6 decreases from the mid-plane 130 up to the top plane 140. In this embodiment, the core may follow the curvature of the skirt. Having the skirt which is wider around the waist compared to the bottom and the top, and curving in toward the earbud provides better stability of the earbud when inserted into the ear.

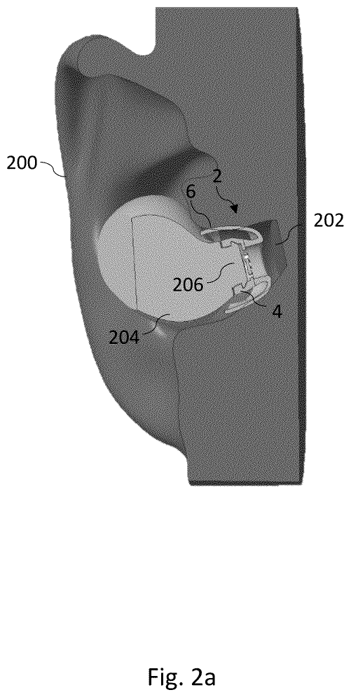

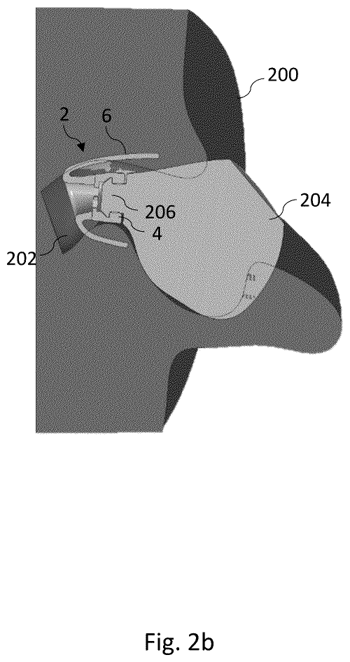

FIGS. 2a and 2b illustrate an eartip 2 arranged on a hearing device 204 and in a user's ear 200. FIG. 2a shows front view of the hearing device 204 inserted in the user's ear 200. FIG. 2b shows view from the top of the ear canal. The core 4 of the eartip is arranged on a speaker tower 206 of the hearing device. When arranged at the hearing device 204, the eartip bottom end 12 is configured to be proximate to the hearing device 204, while the eartip top end is configured to be distal from the hearing device 204 (right side of the drawing). The eartip 2 is arranged in the first bend 202 of the ear canal. The eartip 2 is shaped to follow the first bend 202 of the ear canal and also, due to properties, such as softness, of the skirt 6, the skirt can be additionally shaped by the ear canal. The same eartip 2 can be used for both left and right mounting as it is symmetrical around a first vertical central plane. The symmetry around the first vertical central plane is shown in FIG. 2a. The eartip 2 is angled to better follow the first bend 202 of the ear and thereby follows canal shape. The circumference of the skirt 6 may be elliptical. The eartip 2 is asymmetrical around a second vertical central plane, such that the skirt 6 defines a first height forward of the second vertical central plane and a second height backward of the second vertical central plane, the first height being shorter than the second height. This asymmetry is shown in FIG. 2b.

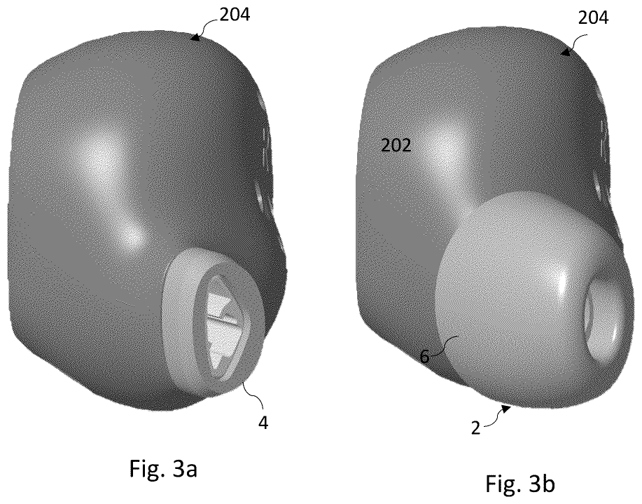

FIGS. 3a and 3b schematically illustrate the eartip 2 arranged on the hearing device 204. FIG. 3a shows only the core 4 of the eartip 2 arranged on the speaker tower of the hearing device 204. In the illustrated embodiment, the unidirectional interface has an essential triangular cross-sectional shape. The core 4 may be made in a first step of a 2-k injection molding from a material having a second hardness value. The skirt may be made in a second step, i.e. second shot, of the 2-k injection molding from a material having a first hardness value. The first hardness value is lower than the second hardness value. The materials used for the core and the skirt may be the same or may be different. The core may define two sections, a first section of the core may form the engagement for the hearing device, and the second section may only form the remaining inner channel. The first section may have the unidirectional profile throughout its entire length while the second section may have an oval profile.

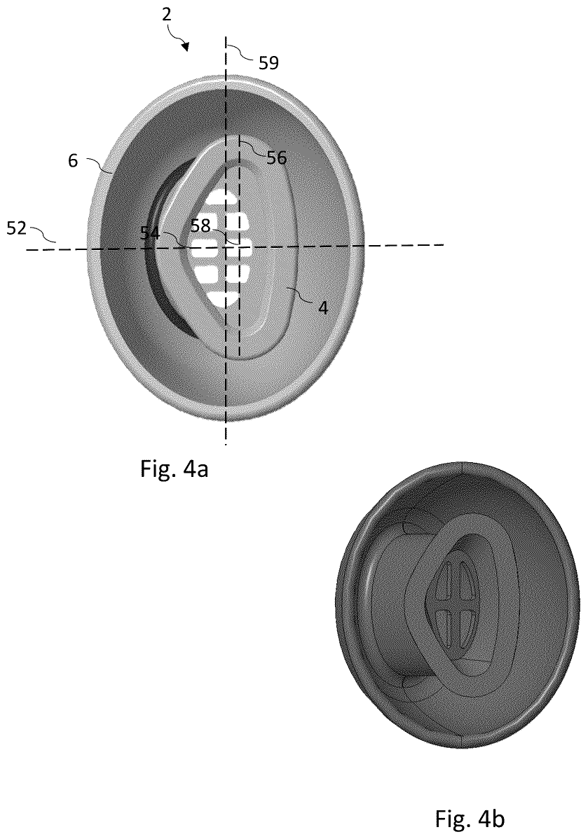

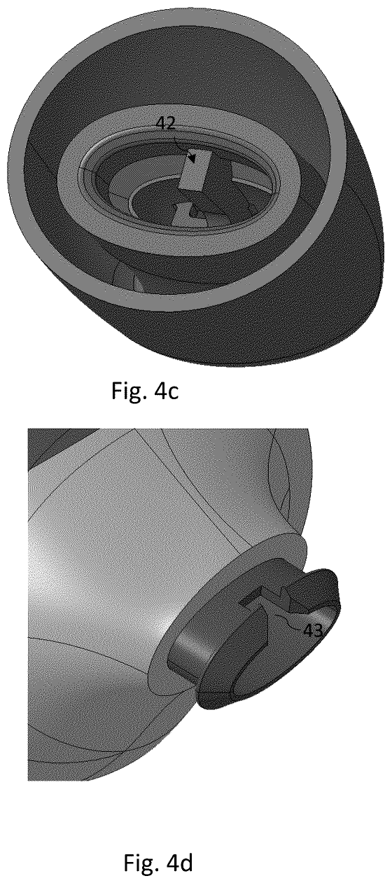

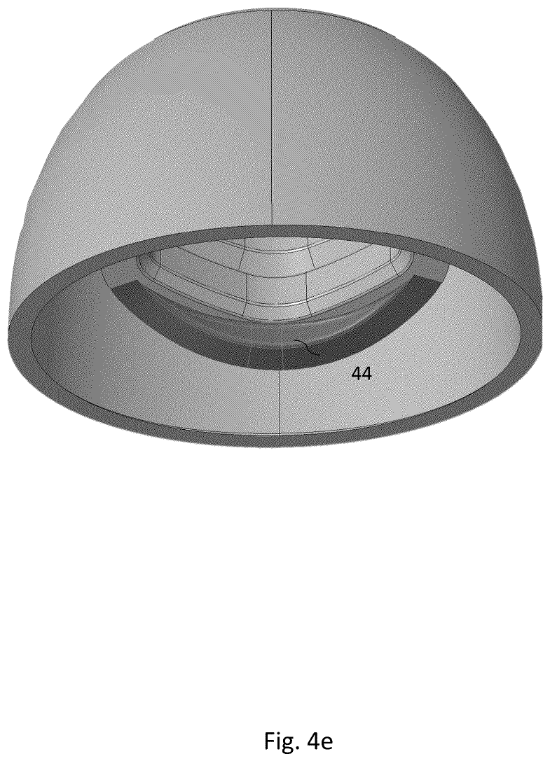

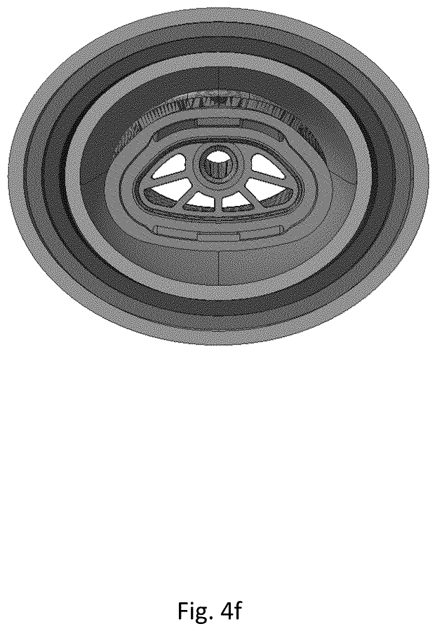

FIG. 4a schematically illustrates a bottom view of an eartip 2 for a hearing device according to one embodiment of the invention. In this embodiment, the eartip core 4 has a triangular unidirectional interface and a skirt 6 being elliptical shape. The unidirectional interface ensures that the eartip can be fitted onto the hearing device only in one way. It is beneficial to have the unidirectional interface between the eartip and the hearing device to guide the user how to arrange the eartip and also to provide a secure and tight fit between the eartip and the hearing device thereby improving sound properties of the hearing device. The bottom end of the skirt is symmetrical along the minor bottom axis 52. The bottom opening of the core 4 is also symmetrical along the axis 54 that lies in the same plane as the minor bottom axis 52. In some embodiments, these two axis may coincide if the bottom opening of the core lies in the same plane as the bottom end of the skirt. The bottom opening of the core is asymmetrical along the axis 56 that is perpendicular to the axis of symmetry 54 of the bottom opening and comprises the centroid 58 of the bottom opening. The bottom opening is asymmetrical around any axis that passes through the centroid 58 and is different from the axis of symmetry 54. FIG. 4b schematically illustrates a bottom side view of the eartip 2 shown in FIG. 4a.

In some embodiments, the eartip 2 is symmetrical around a first vertical central plane that comprise the minor bottom axis 52 and the axis of symmetry 54 of the bottom opening. Thereby, the eartip is configured to be used for both the left and the right ear of a user. The eartip is asymmetrical around a second vertical central plane that comprises the major bottom axis 59 and is perpendicular to the bottom end of the skirt 6.

In another embodiment, the unidirectional interface may define any other cross-section that ensures only one way of fitting the eartip onto the speaker tower. The unidirectional interface has a cross-section that matches a cross-section of the speaker tower of the hearing device thereby ensuring tight mating there between.

FIG. 4c schematically illustrates a bottom view of an eartip for a hearing device according to one embodiment of the invention. In this embodiment, the eartip core has an oval shape with a rib 42 resulting in a unidirectional interface. The skirt is of elliptical shape. The rib 42 is configured to fit in a slot 43 formed in the speaker tower of the hearing device, as illustrated in FIG. 4d.

FIG. 4e schematically illustrates a bottom view of an eartip for a hearing device according to yet one embodiment of the invention. The eartip core has a generally oval shape provided with a locking feature 44 (a protrusion) on one side of the eargel core resulting in a unidirectional interface.

FIG. 4f schematically illustrates a bottom view of an eartip for a hearing device according to yet one embodiment of the invention. The eartip core has a substantially trapezoidal shape resulting in a unidirectional interface. The trapezoidal shape may define two sides that are essentially parallel to each other, wherein one side is shorter than the other. The trapezoidal unidirectional interface may have rounded edges.

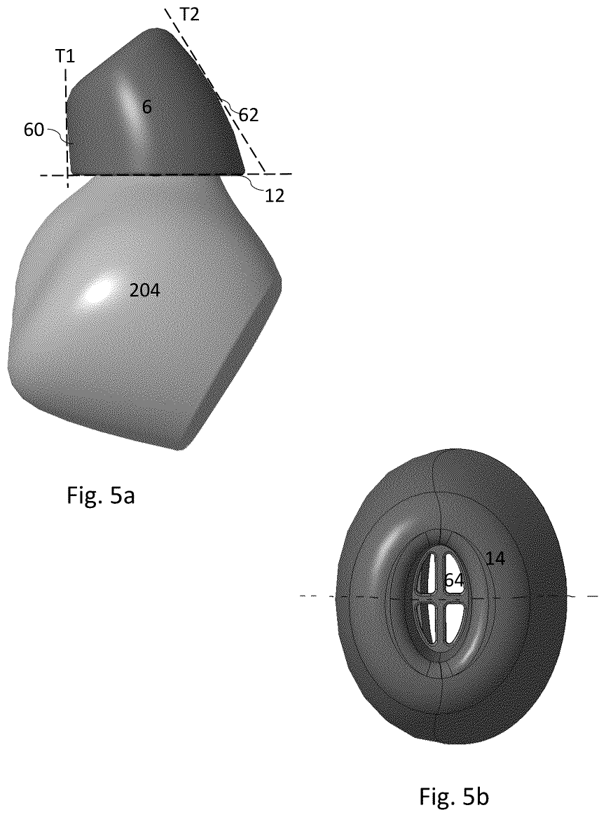

FIGS. 5a and 5b schematically illustrate an anterior (a) and top (b) view of an eartip for a hearing device according to one embodiment of the invention. From the anterior view, FIG. 5a, only the skirt 6 of the eartip (arranged on the hearing device 204) is visible and its overall shape. In this embodiment, the skirt exhibits different heights on two opposing sides of the eartip. One side, posterior curve 60 (typically facing the back of the user when the hearing device with the eartip is arranged in the ear), is substantially perpendicular (±10° deg) to the bottom end, i.e. a tangent T1 to the inner curve 60 may form a straight or obtuse angle with the bottom end 12 while the opposite, anterior, side 62 is curved and forms an acute angle with the bottom end of the skirt. i.e. a tangent T2 to the opposite curve 62 may form an acute angle with the bottom end thereby defining an angled eartip shaped to facilitate insertion into the first bend of the ear canal. The posterior curve 60 may have a shorter length (measuring from the bottom end to the top end) compared to the opposite, anterior, curve 62. The height of the eartip may be shorter than the length of the opposite curve 62. From the top view, FIG. 5b, the top end 14 and a grid 64 formed in the inner channel of the core are visible. The top end 14 may have an oval shape and a smaller cross section than the bottom end.

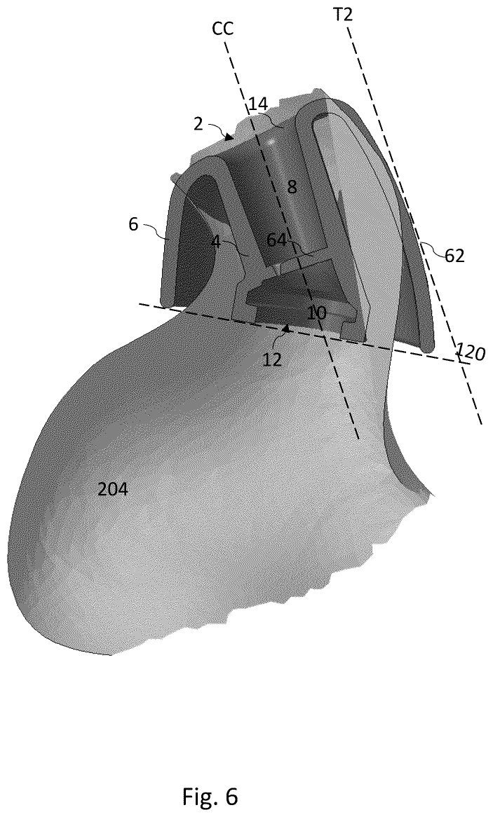

FIG. 6 schematically illustrates an eartip 2 according to one embodiment of the invention. The eartip 2 is arranged on the hearing device 204. In this embodiment, the bottom opening 10 forming the unidirectional interface is in the same plane 120 as the bottom end 12 of the skirt 6. The grid 64 is substantially parallel to the top end 14 of the skirt. The core 8 is angled and forms an acute angle with the bottom plane 120. The core, i.e. its central axis CC may be parallel to the tangent T2 to the anterior curve 62 (typically facing towards the front of the user when the hearing device with the eartip is arranged in the ear). Such angled core and one of the sides of the eartip facilitates insertion of the eartip 2 into the user's ear.

Although particular features have been shown and described, it will be understood that they are not intended to limit the claimed invention, and it will be made obvious to those skilled in the art that various changes and modifications may be made without departing from the scope of the claimed invention. The specification and drawings are, accordingly to be regarded in an illustrative rather than restrictive sense. The claimed invention is intended to cover all alternatives, modifications and equivalents, as well as combination of various embodiments illustrated in the figures.

### ITEMS

1. An eartip (2) for a hearing device, the eartip (2) comprising a core (4) and a skirt (6) formed around the core, the core (4) forming an inner channel (8) with a top opening (9) and a bottom opening (10) for detachably attaching the eartip to the hearing device,
   the eartip defining an eartip bottom end (12) and an eartip top end (14), a bottom plane (120) of the bottom end (12) and a top plane (140) of the top end (14) being configured to intersect in space, and wherein the perimeter of the skirt (6) is configured to change from the bottom plane (120) towards the top plane (140), the bottom opening (10) forming a unidirectional interface, wherein the unidirectional cross-section is convex.
2. The eartip according to item 1, wherein the unidirectional interface has a cross-section that matches a cross-section of a speaker tower of the hearing device.
3. The eartip according to item 1 or 2, wherein the unidirectional interface defines a fitment inside the inner channel of the core.
4. The eartip according to any of the preceding items, wherein the unidirectional interface forms a polygon.
5. The eartip according to any of the items 1-3, wherein the unidirectional interface comprises straight lines and curved lines.
6. The eartip according to any of the preceding items, wherein the unidirectional interface has an essential triangular cross-sectional shape, or trapezoidal cross-sectional shape, or pentagonal cross-sectional shape.
7. The eartip according to any of the preceding items, wherein the eartip bottom end (12) is configured to be proximate to the hearing device, and wherein the eartip top end (14) is configured to be distal from the hearing device, when the eartip is arranged at the hearing device.
8. The eartip according to any of the preceding items, wherein the eartip is symmetrical around a first vertical central plane such that the eartip is configured to be used for both the left and the right ear of a user.
9. The eartip according to any of the preceding items, wherein the eartip is asymmetrical around a second vertical central plane, such that the skirt defines a first height forward of the second vertical central plane and a second height backward of the second vertical central plane, the first height being shorter than the second height.
10. The eartip according to any of the preceding items, wherein a center of the bottom end of the eartip is off-set with respect to a center of the top end of the eartip such that the eartip is tilted with respect to a second vertical central plane.
11. The eartip according to any of the preceding items, wherein the top end is angled with respect to the bottom end.
12. The eartip according to any of the preceding items, wherein the eartip defines a bend between the bottom end and the top end, the bend comprising an interior curve and an opposite curve that are sized and shaped to facilitate insertion of the eartip at or near a first bend of the ear canal and wherein the core is configured to bend at or near the first bend of the ear canal.
13. The eartip according to any of the preceding items, wherein the eartip is made of a thermoplastic elastomer.
14. The eartip according to any of the preceding items, wherein the skirt has a first hardness value, and wherein the core has a second hardness value, and wherein the first hardness value is lower than the second hardness value.
15. The eartip according to any of the preceding items, wherein the core comprises a section that is tilted with respect to a speaker tower of the hearing device, when the eartip is arranged at the hearing device.
16. The eartip according to any of the preceding items, wherein the core and the skirt are integrally connected thereby forming the top end of the eartip.
17. The eartip according to any of the preceding items, wherein the inner channel of the core comprises a grid arranged within the channel.
18. The eartip according to any of the preceding items, wherein the horizontal cross-section of the eartip is substantially oval.
19. The eartip according to any of the preceding items, wherein the bottom opening for interfacing the eartip with the hearing device comprises a protrusion configured to seal the interface between the eartip and the hearing device.
20 The eartip according to any of the preceding items, wherein the eartip is configured to at least partly acoustically seal an ear of the hearing device user.
21. The eartip according to any of the preceding items, wherein the eartip is configured to retain the hearing device in an ear of the hearing device user.
22. The eartip according to any of the preceding items, wherein the core is shorter than the skirt.
23. The eartip according to any of the preceding items, wherein the perimeter of the skirt (6) is configured to decrease from the bottom plane (120) towards the top plane (140).
24. The eartip according to any of the preceding items, wherein the perimeter of the skirt (6) is configured to increase from the bottom plane up to a mid-plane between the bottom plane and the top plane, and wherein the circumference of the skirt (6) is configured to decrease from the mid-plane up to the top plane.

LIST OF REFERENCES

| | |
|---|---|
| 2 | eartip |
| 4 | core |
| 6 | skirt |
| 8 | inner channel |
| 10 | bottom opening |
| 12 | bottom end |
| 120 | bottom plane |
| 14 | top end |
| 140 | top plane |
| 160 | second vertical central plane |
| H1 | first skirt height |
| H2 | second skirt height |
| CB | bottom end center |
| CT | top end center |
| CC | central axis of the core |
| 200 | user's ear |
| 202 | first bend of the ear canal |
| 204 | hearing device |
| 206 | speaker tower |
| 42 | rib |
| 43 | slot |
| 44 | locking feature |
| 52 | minor bottom axis |
| 54 | axis of symmetry of the bottom opening |
| 58 | centroid of the bottom opening |
| 59 | major bottom axis |
| 60 | posterior curvature |
| 62 | anterior curvature |
| T1 | tangent of the interior curvature |
| 62 | opposite curvature |
| T2 | tangent of the opposite curvature |
| 64 | grid |

1. An eartip for a hearing device, the eartip comprising a core and a skirt formed around the core, the core forming an inner channel with a top opening and a bottom opening for detachably attaching the eartip to the hearing device,
the eartip defining an eartip bottom end and an eartip top end, a bottom plane of the bottom end and a top plane of the top end being configured to intersect in space, and wherein the perimeter of the skirt is configured to change from the bottom plane towards the top plane,
the bottom opening forming a unidirectional interface, wherein the unidirectional cross-section is convex.

2. The eartip according to claim 1, wherein the unidirectional interface has a cross-section that matches a cross-section of a speaker tower of the hearing device.

3. The eartip according to claim 1, wherein the unidirectional interface defines a fitment inside the inner channel of the core.

4. The eartip according to claim 1, wherein the unidirectional interface forms a polygon.

5. The eartip according to claim 1, wherein the unidirectional interface comprise straight lines and curved lines.

6. The eartip according to claim 1, wherein the unidirectional interface has an essential triangular cross-sectional shape, or trapezoidal cross-sectional shape, or pentagonal cross-sectional shape.

7. The eartip according to claim 1, wherein the eartip is symmetrical around a first vertical central plane such that the eartip is configured to be used for both the left and the right ear of a user.

8. The eartip according to claim 1, wherein the eartip is asymmetrical around a second vertical central plane, such that the skirt defines a first height forward of the second vertical central plane and a second height backward of the second vertical central plane, the first height being shorter than the second height.

9. The eartip according to claim 1, wherein a center of the bottom end of the eartip is off-set with respect to a center of the top end of the eartip such that the eartip is tilted with respect to a second vertical central plane.

10. The eartip according to claim 1, wherein the eartip defines a bend between the bottom end and the top end, the bend comprising an interior curve and an opposite curve that are sized and shaped to facilitate insertion of the eartip at or near a first bend of the ear canal and wherein the core is configured to bend at or near the first bend of the ear canal.

11. The eartip according to claim 1, wherein the skirt has a first hardness value, and wherein the core has a second hardness value, and wherein the first hardness value is lower than the second hardness value.

12. The eartip according to claim 1, wherein the core comprises a section that is tilted with respect to a speaker tower of the hearing device, when the eartip is arranged at the hearing device.

13. The eartip according to claim 1, wherein the core and the skirt are integrally connected thereby forming the top end of the eartip.

14. The eartip according to claim 1, wherein the inner channel of the core comprises a grid arranged within the channel.

15. The eartip according to claim 1, wherein the horizontal cross-section of the eartip is substantially oval, wherein the oval unidirectional cross-section comprises a groove.

16. The eartip according to claim 1, wherein the perimeter of the skirt (6) is configured to decrease from the bottom plane (120) towards the top plane (140).

17. The eartip according to claim 1, wherein the perimeter of the skirt (6) is configured to increase from the bottom plane up to a mid-plane between the bottom plane and the top plane, and wherein the circumference of the skirt (6) is configured to decrease from the mid-plane up to the top plane.

18. The eartip according to claim 4, wherein the triangular unidirectional cross-section forms an isosceles triangle or a scalene triangle.
